(19) United States
(12) Patent Application Publication
(10) Pub. No.: US 2015/0116535 A1
(43) Pub. Date: Apr. 30, 2015

(54) WHITE-BALANCE COLOR TEMPERATURE MEASURING DEVICE FOR IMAGE PICK-UP DEVICE

(71) Applicants: FU-CHI WU, NORTHRIDGE, CA (US); STEVEN WU, LOS ANGELES, CA (US)

(72) Inventors: FU-CHI WU, NORTHRIDGE, CA (US); STEVEN WU, LOS ANGELES, CA (US)

(21) Appl. No.: 14/066,872

(22) Filed: Oct. 30, 2013

(51) Int. Cl. H04N 9/73; H04N 9/64

(52) U.S. Cl. CPC H04N 9/735; H04N 9/646
USPC 348/224.1

(57) ABSTRACT

A white-balance color temperature measuring device for image pick-up device includes a white or gray light transmitting sheet and a color temperature sensing element and installed in a camera body of a camera, camera phone, video camera or any other image pick-up device such that when focusing or pressing the shutter, incident light is changed by white or gray light transmitting sheet into a neutral light that falls upon the color temperature sensing element, causing the color temperature sensing element to induce a spot color temperature signal and to provide the signal to a CPU for processing, and thus, the color of the captured photos or images can be close to the natural colors of the shooting scene.

### BACKGROUND OF THE INVENTION

1. Field of the Invention

The present invention relates to image pick-up technology, and more particularly, to a white-balance color temperature measuring device for use in the camera lens light path or camera body of a camera, video camera, camera phone or tablet PC or any other image pick-up device, which includes a comb, which comprises a white or gray light transmitting sheet and a color temperature sensing element disposed behind the white or gray light transmitting sheet for obtaining an accurate color temperature value, enabling the color of the captured photos or images to be close to the natural color of the shooting scene.

2. Description of the Related Art

At the present time, commercial developments have leaded economic prosperity, and thus the quality of life of people has been greatly enhanced. In addition to food, clothing, shelter and transportation, tourism and leisure activities have become major projects of people to relieve stress. Therefore, in order to keep the various memories in daily life, people use camera, video camera or camera phone to take pictures. Further, professional cameras or video cameras are widely used for wedding photography and professional photography. However, most people have the common feeling that there is a significant difference between the colors of the photographed pictures or videos and the colors of the scenes even an advanced camera or video camera with a high-level CPU and a high-level CCD or CMOS image sensor is used. Although, thanks to technology, the currently marketed cameras, video cameras or camera phones commonly have an automatic white balance function built therein that greatly improves the problems of color shift. However, when shooting different scenes and there are often many different colors of mixed light scenes. When mixed light enters the camera or video camera, the white balance processing block of the built-in image processor of the camera or video camera can simply simulate an approximate value, causing a color distortion of the photographed pictures or videos, and thus, the colors of the photographed pictures or videos do not match the colors of the scenes. White balance establishes color temperature. Color temperature is a characteristic of visible light. The color temperature of a light source is the temperature of an ideal black body radiator that radiates light of comparable hue to that of the light source. In practice, color temperature is only meaningful for light sources that do in fact correspond somewhat closely to the radiation of some black body. Low color temperature implies warmer (more yellow/red) light while high color temperature implies a colder (more blue) light. Daylight has a rather low color temperature near dawn, and a higher one during the day. When photographing under tungsten light, the color temperature implies yellowish light. These phenomena occur due to a color shift that happens just because the color temperature does not meet the film's color standard. Therefore, the current white balance problem bothers people. It is also a big problem with professional photographers. Professional photographers have all kinds of auxiliary software, however, they need to spend a lot of time and effort to make white balance correction. Therefore, a professional photographer needs to use an expensive color temperature measuring equipment (colorimeter or color temperature meter) to detect the color temperature of the scene and then to correct the color temperature of the camera or video camera prior to photography. When multiple cameras or video cameras are used, assistants need to detect the color temperature of the environment of the shooting scene with a colorimeter, and then to correct the color temperature value of every camera or video camera, thereby saving the shooting time. However, this procedure is complicated and time consuming. Further, it is expensive to prepare the related equipments.

Commercial image pick-up devices do not have an independent white-balance sensor. When the CCD or CMOS image sensor of an image pick-up device catches the light of the scene, the light value is provided to a CPU for auto white balance computing. If the locally available light source and the ambient color changes quickly or lacks pure white standard, the automatic white balance logic computing frequently gets an error, and the pictures or videos thus obtained can have an incorrect color temperature (i.e., color distortion).

The simple color temperature settings (sunny, rainy, dusk, incandescent light, fluorescent light, etc.) of a camera or video camera cannot accurately match the correct color temperature of the light source of the scene for taking pictures or videos having the correct color temperature.

Currently, the most advanced SLR (Single Lens Reflex) camera or VCR (Video Cassette Recorder) completely depends upon the performance of a RGB light sensor image sensor in making color temperature logical computing, however, the computing normally fails to get the accurate scene color temperature, and the pictures or videos thus obtained can have distorted colors.

Using filtered light, white or neutral gray light, and an independent color temperature measuring device to measure the accurate scene color temperature value, you can completely solve the problem of color distortion.

### SUMMARY OF THE INVENTION

The present invention has been accomplished under the circumstances in view. It is therefore the main object of the present invention to provide a white-balance color temperature measuring device for use in a camera, video camera, camera phone or tablet PC or any other image pick-up device, which includes a comb, which automatically obtains an accurate color temperature value without any adjustment or color temperature detection, enabling the color of the captured photos or images to be close to the natural color of the shooting scene.

To achieve this and other objects of the present invention, a white-balance color temperature measuring device of the invention comprises a white or gray light transmitting sheet and a color temperature sensing element and installed in a camera body of a camera, video camera or image pick-up device, for enabling incident light passing through a camera lens into a CCD or CMOS image sensor to be synchronously changed by said white or gray light transmitting sheet into a neutral light that falls upon the color temperature sensing element, causing the color temperature sensing element to induce a spot color temperature signal and to provide the signal to a CPU of the camera, video camera or image pick-up device where the CPU runs a white balance calculation processing on the retrieved color temperature value to obtain an accurate white balance (color temperature) value, so that the color of the captured photos or images becomes close to the natural color of the shooting scene.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a schematic perspective exploded view of a white-balance color temperature measuring device in accordance with one embodiment of the present invention.

FIG. 2 is a schematic sectional side view of the embodiment shown in FIG. 1.

FIG. 3 illustrates the white or gray light transmitting sheet and color temperature sensing element of the white-balance color temperature measuring device installed in a passage hole in the camera body in accordance with the present invention.

FIG. 4 is a schematic sectional view of the embodiment shown in FIG. 3.

FIG. 5 illustrates the white or gray light transmitting sheet and color temperature sensing element of the white-balance color temperature measuring device installed in the light path in the camera in accordance with the present invention.

FIG. 6 is a schematic perspective view of the present invention, illustrating the white or gray light transmitting sheet and color temperature sensing element of the white-balance color temperature measuring device installed in the light path of the camera lens around the image sensor of a non-prism reflector, non-pentaprism, interchangeable lens camera.

FIG. 7 is a schematic sectional view of the present invention, illustrating the white or gray light transmitting sheet and color temperature sensing element of the white-balance color temperature measuring device installed in the light path of the camera lens around the image sensor of a non-prism reflector, non-pentaprism, interchangeable lens camera.

FIG. 7A is a schematic perspective view of the present invention, illustrating the white or gray light transmitting sheet and the color temperature sensing element directly installed in the border area of the camera lens.

FIG. 7B is a schematic sectional view of the present invention, illustrating the white or gray light transmitting sheet mounted beyond the image range of a CCD or CMOS image sensor.

FIG. 7C is a schematic front view of the present invention, illustrating the white or gray light transmitting sheet mounted beyond the image range of a CCD or CMOS image sensor.

FIG. 8 is a schematic perspective view of the present invention, illustrating the white or gray light transmitting sheet and the color temperature sensing element mounted adjacent to one side of a flash of a camera phone.

FIG. 9 is a schematic sectional side view of the present invention, illustrating the white or gray light transmitting sheet and the color temperature sensing element mounted adjacent to one side of a flash of a camera phone.

FIG. 10 is a schematic perspective view of the present invention, illustrating the white or gray light transmitting sheet and the color temperature sensing element mounted adjacent to a rear camera lens of a camera phone.

FIG. 11 is a schematic perspective view of the present invention, illustrating the white or gray light transmitting sheet and the color temperature sensing element mounted adjacent to a front camera lens of a camera phone.

FIG. 12 is an exploded view illustrating the mounting relationship between a vertical type detachable white-balance color temperature measuring device and a jack in a camera body or camera lens of a camera in accordance with the present invention.

FIG. 13 is an exploded view illustrating the mounting relationship between a horizontal type detachable white-balance color temperature measuring device and a jack in a camera body of a camera in accordance with the present invention.

FIG. 14 is an exploded view illustrating the mounting relationship between a flash attachment mounting type detachable white-balance color temperature measuring device and a flash attachment of a camera in accordance with the present invention.

FIG. 15 is a schematic drawing of the present invention, illustrating a detachable white-balance color temperature measuring device installed in a tripod for wireless communication with a camera phone or camera.

### DETAILED DESCRIPTION OF THE PREFERRED EMBODIMENT

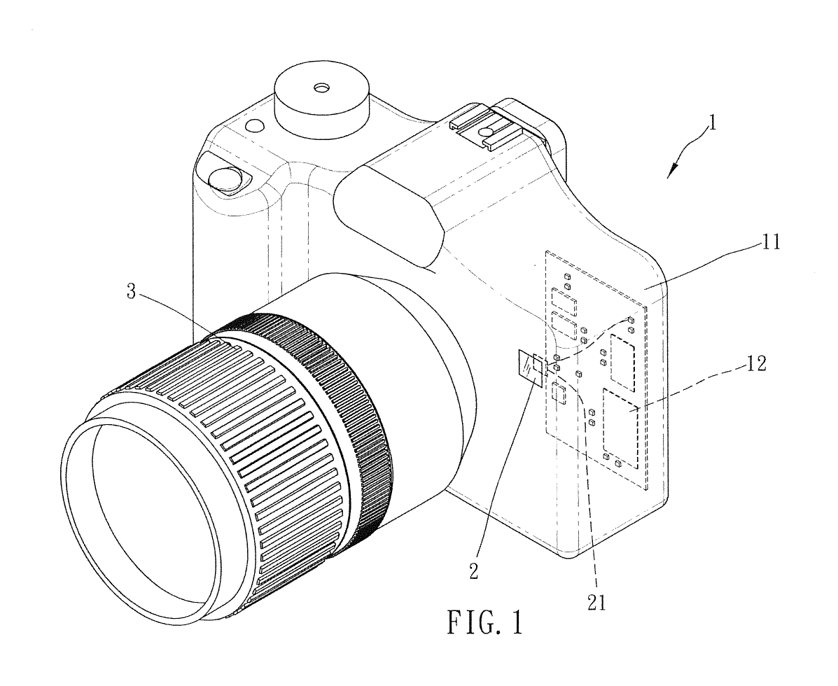

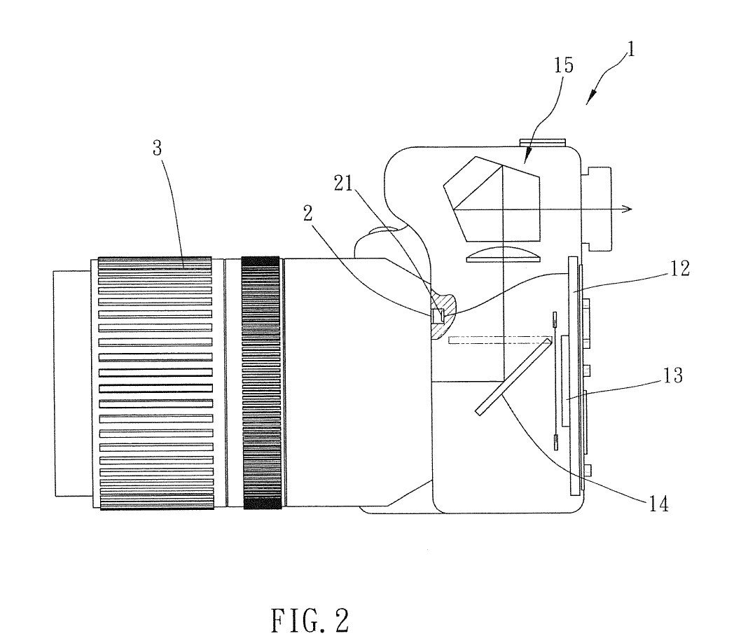

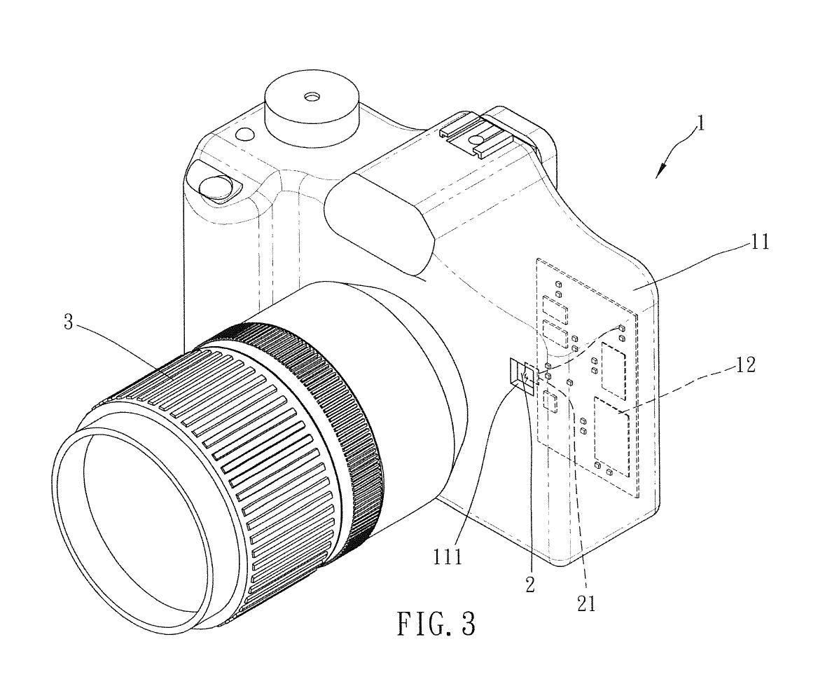

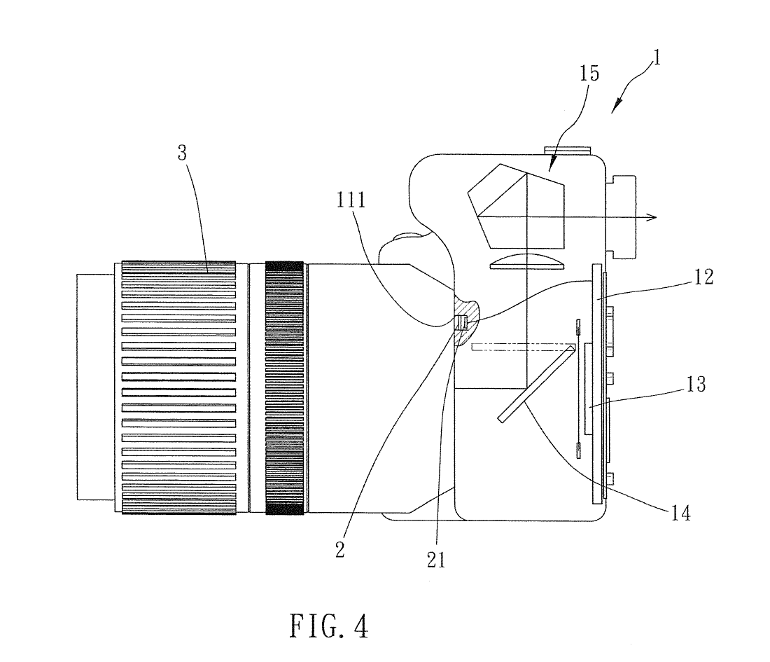

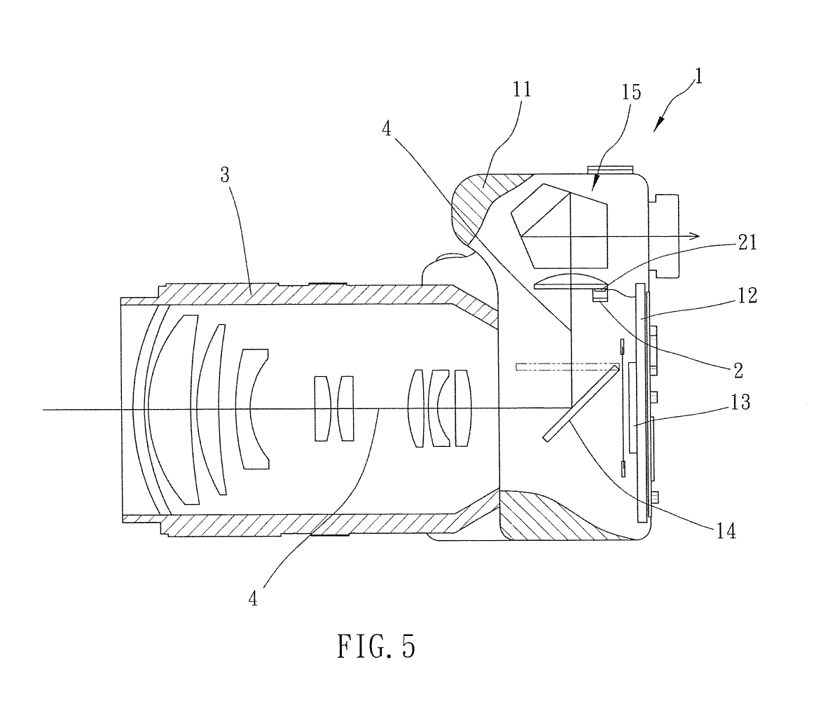

Referring to FIG. 1, FIG. 2, FIG. 3, FIG. 4 and FIG. 5, a white-balance color temperature measuring device is shown installed in an image pick-up device in accordance with the present invention is shown installed in the camera body 11 of an image pick-up device 1, for example, camera, or the light path 4 in the camera body 11 of the image pick-up device 1 that extends through the camera lens 3 of the image pick-up device 1. The white-balance color temperature measuring device comprises a white or gray light transmitting sheet 2 and a color temperature sensing element 21. When focusing or pressing the shutter to take pictures, the reflective mirror 14 flips for allowing the external image to be projected onto the image sensor 13. At this time, external light passing through the white or gray light transmitting sheet 2 is changed into uniform neutral light that falls upon the color temperature sensing element 21, causing the color temperature sensing element 21 to induce a spot color temperature signal and to provide the signal to the CPU 12 of the camera, video camera or any other image pick-up device 1, where the CPU 12 runs a white balance calculation processing on the retrieved color temperature value to obtain an accurate white balance (color temperature) value so that the color of the captured photos or images can be close to the natural color of the shooting scene. In the embodiment shown in FIG. 1 and FIG. 2, the white or gray light transmitting sheet 2 and the color temperature sensing element 21 are mounted inside a camera body 11 where the camera body 11 provides an accommodation chamber for accommodating the white or gray light transmitting sheet 2 and the color temperature sensing element 21. In the embodiment shown in FIG. 3 and FIG. 4 the white or gray light transmitting sheet 2 and the color temperature sensing element 21 are installed in a passage hole 111 in a camera body 11. In the embodiment shown in FIG. 5, the white or gray light transmitting sheet 2 and the color temperature sensing element 21 are mounted within a camera body 11 in an light path 4 of a camera lens 3, for example, beneath a pentaprism 15 without affecting the line of sight. When external light passes through the camera lens 3 into the light path 4, it falls upon the white or gray light transmitting sheet 2 and is then changed into uniform neutral light, and then guided to the color temperature sensing element 21.

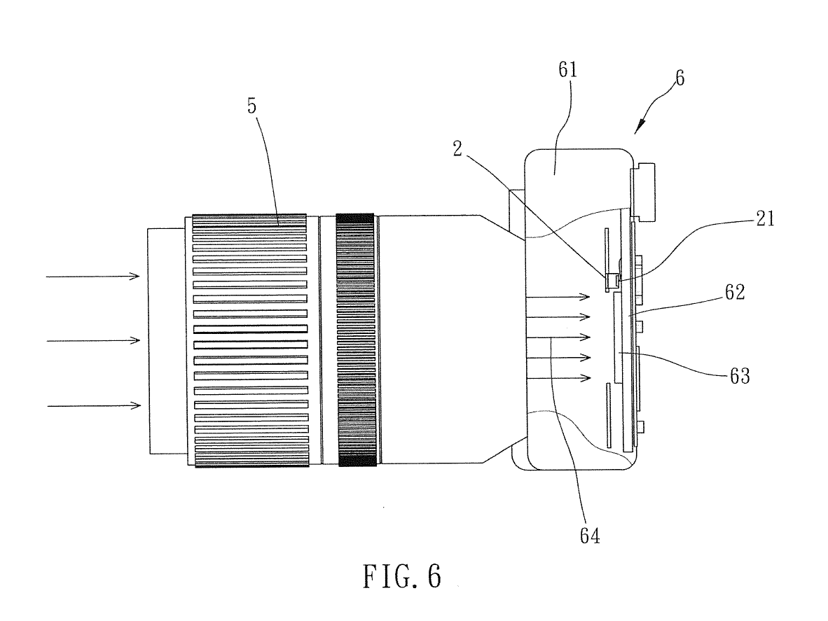

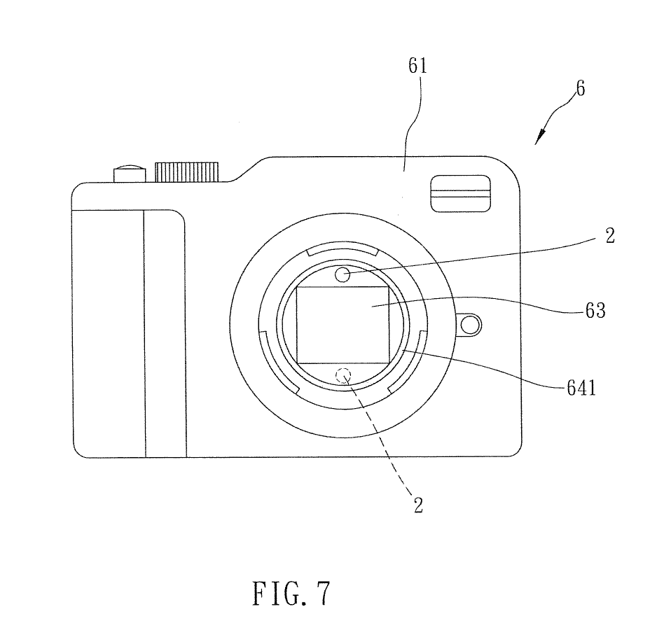

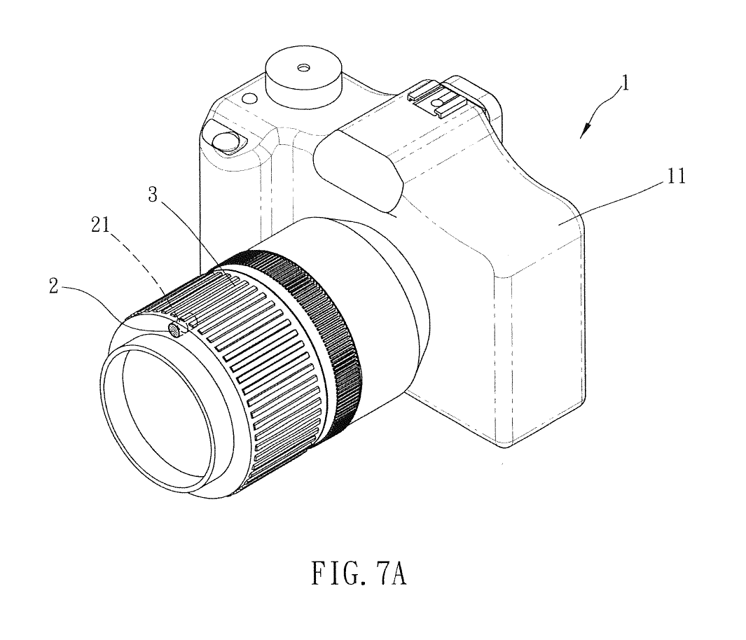

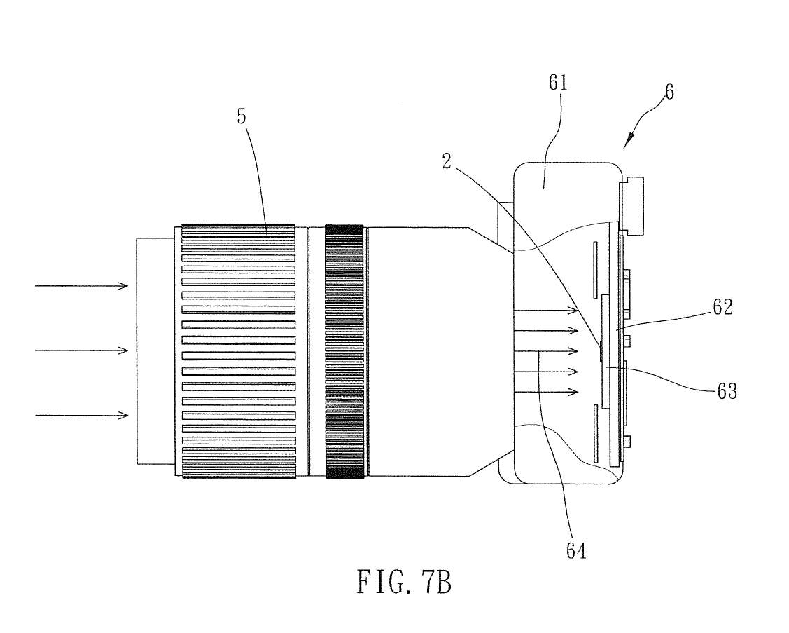

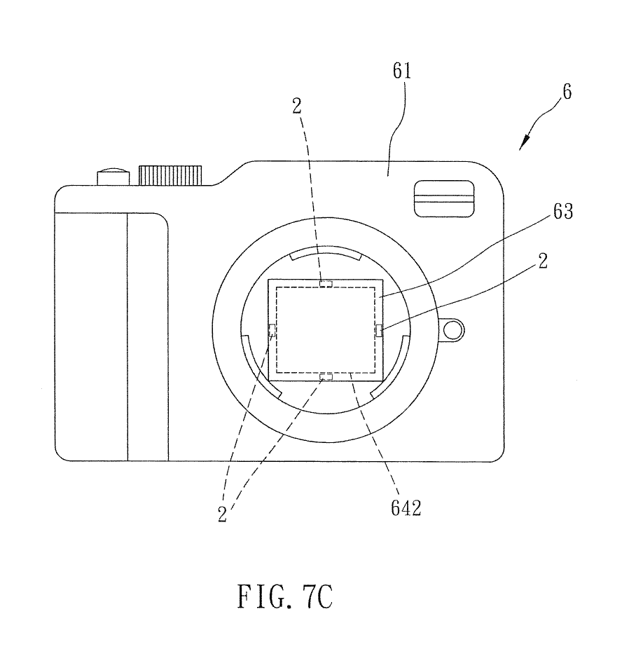

In the embodiment shown in FIG. 6 and FIG. 7, the white or gray light transmitting sheet 2 and the color temperature sensing element 21 are mounted within a camera body 61 of a non-prism reflector, non-pentaprism, interchangeable lens camera 6 in an light path 64 of a camera lens 5 within an optical range 641 of a CCD (charge coupled device) or CMOS (complementary metal-oxide-semiconductor) image sensor 63 in the camera body 61.

When focusing or pressing the shutter to take pictures, external light passes through the camera lens 5 into the light path 64 and is then changed by the white or gray light transmitting sheet 2 into uniform neutral light that falls upon the color temperature sensing element 21, causing the color temperature sensing element 21 to induce a spot color temperature signal and to provide the signal to a CPU 62 of the non-prism reflector, non-pentaprism, interchangeable lens camera 6, where the CPU 62 runs a white balance calculation processing on the retrieved color temperature value to obtain an accurate white balance (color temperature) value. Alternatively, the white or gray light transmitting sheet 2 and the color temperature sensing element 21 can be mounted in a border area of a camera lens 3 of a camera, video camera or any other image pick-up device 1 (see FIG. 7A). The white or gray light transmitting sheet 2 and the color temperature sensing element 21 can also be mounted in a camera 6 beyond the image range 642 of a CCD (charge coupled device) or CMOS (complementary metal-oxide-semiconductor) image sensor 63 in a light path 64 of a camera lens 5 of the camera or video camera 6. When focusing or pressing the shutter to take pictures, external light passes through the camera lens 5 of the camera or video camera 6 into the light path 64 and is then changed by the white or gray light transmitting sheet 2 into uniform neutral light that falls upon the CCD (charge coupled device) or CMOS (complementary metal-oxide-semiconductor) image sensor 63, enabling a CPU 62 of the camera or video camera 6 to run a white balance calculation processing on the retrieved color temperature value and to further obtain an accurate white balance (color temperature) value (see FIG. 7B and FIG. 7C).

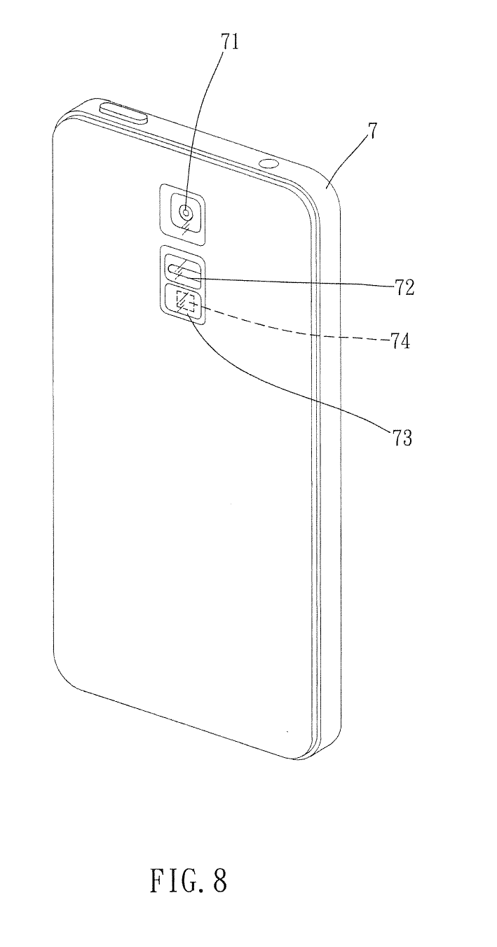

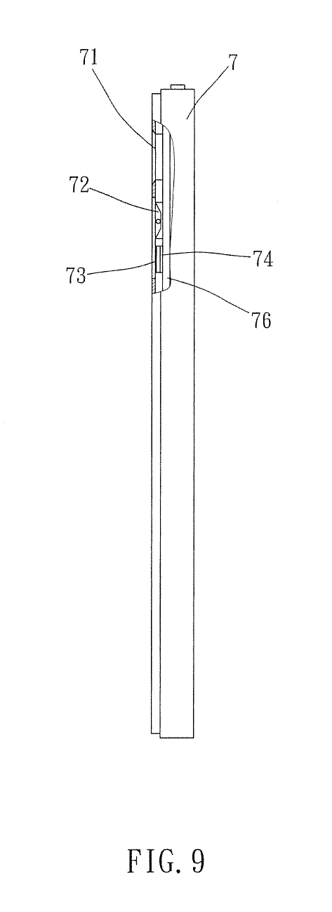

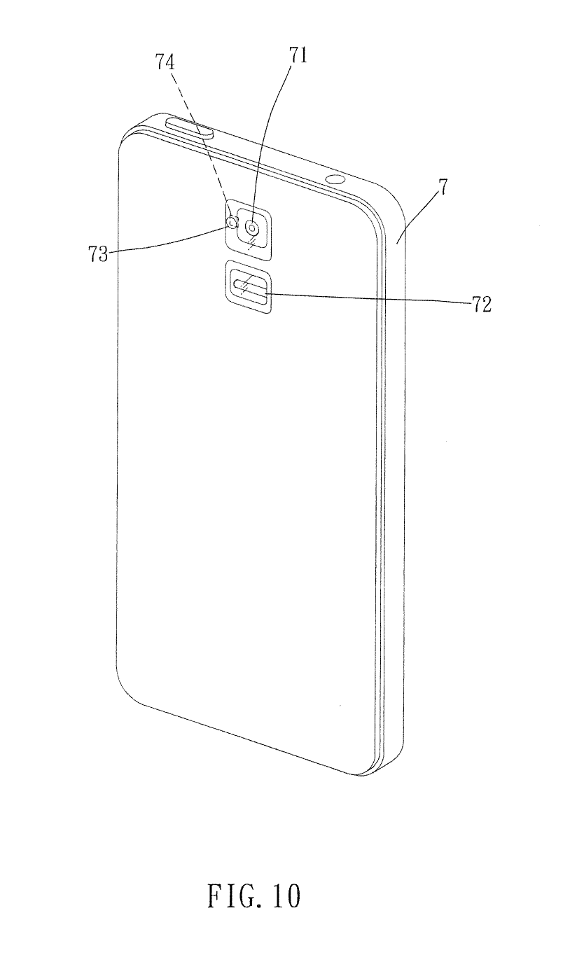

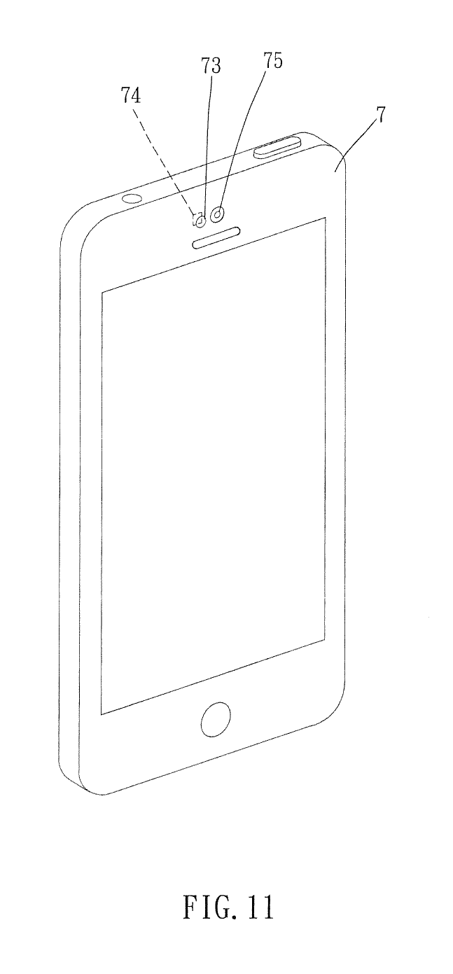

In the embodiment shown in FIG. 8 and FIG. 9, a white or gray light transmitting sheet 73 and a color temperature sensing element 74 are mounted in a light path of a front camera lens 71 or rear camera lens 75 of a camera phone 7 adjacent to a flash light 72. When focusing or pressing the shutter to take pictures, external light passes through the white or gray light transmitting sheet 73 is changed into uniform neutral light that falls upon the color temperature sensing element 74, causing the color temperature sensing element 74 to induce a spot color temperature signal and to provide the signal to a CPU 76 of the camera phone 7, where the CPU 76 runs a white balance calculation processing on the retrieved color temperature value to obtain an accurate white balance (color temperature) value, so that the color of the captured photos or images can be close to the natural color of the shooting scene. Alternatively, the white or gray light transmitting sheet 73 and the color temperature sensing element 74 can also be installed in the camera phone 7 adjacent to one side of the front camera lens 71 or rear camera lens 75 (see FIG. 10 and FIG. 11).

A camera phone 7 having installed therein a white or gray light transmitting sheet 73 and a color temperature sensing element 74 and a white balance algorithm can be operated to obtain a scene white balance value and then to transmit the scene white balance value to a CPU 76 of a image pick-up device 1 by a wired or wireless transmission method for further computing. An application program in the camera phone can also be used to transmit the white balance value.

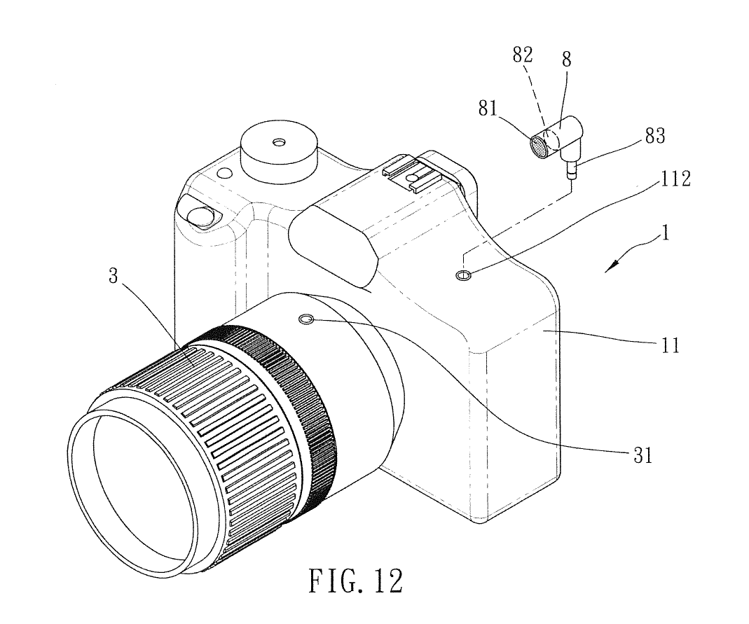

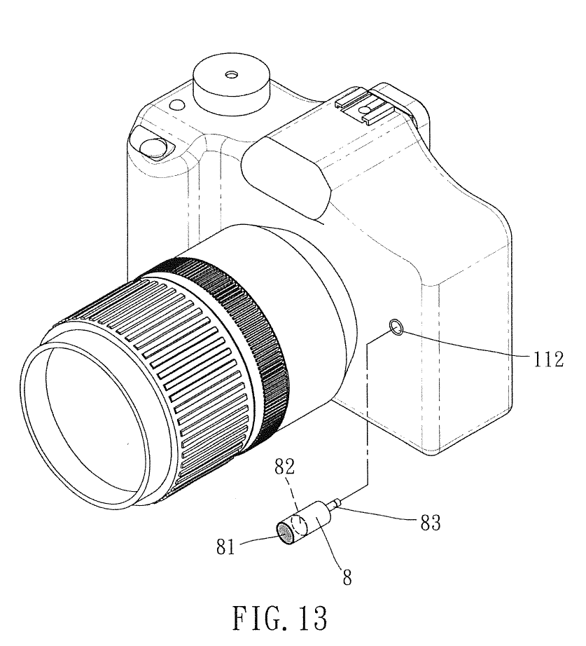

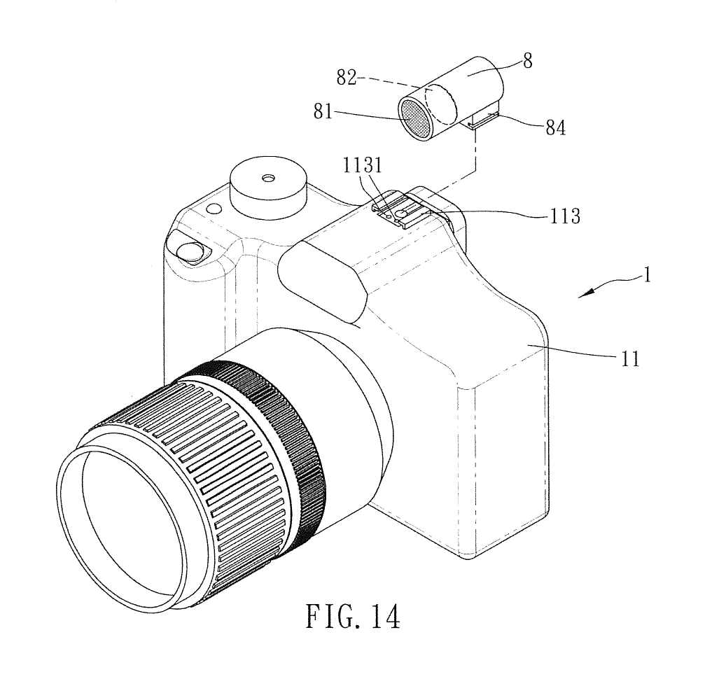

Referring to FIG. 12 and FIG. 13, a detachable white-balance color temperature measuring device 8 is shown comprising a white or gray light transmitting sheet 81, a color temperature sensing element 82 and a power and signal connector 83 mounted within an outer shell thereof. By means of plugging the power and signal connector 83 into a jack 31 or 112 in a camera lens 3 or camera body 11 of a camera, video camera, camera phone, tablet PC or any other image pick-up device 1, the detachable white-balance color temperature measuring device 8 is electrically connected to the image pick-up device 1. External light passing through the white or gray light transmitting sheet 81 is changed into uniform neutral light that falls upon the color temperature sensing element 82, causing the color temperature sensing element 82 to induce a spot color temperature signal and to provide the signal to a CPU 12 of the camera, video camera, camera phone, tablet PC or any other image pick-up device 1, where the CPU 12 runs a white balance calculation processing on the retrieved color temperature value to obtain an accurate white balance (color temperature) value. Further, in the embodiment shown in FIG. 14, the detachable white-balance color temperature measuring device 8 comprises a white or gray light transmitting sheet 81, a color temperature sensing element 82 and a power and signal connecting mount 84. The power and signal connecting mount 84 can be attached to a flash attachment 113 and electrically connected to electric contacts 1131 in the flash attachment 113 for obtaining an accurate white balance (color temperature) signal.

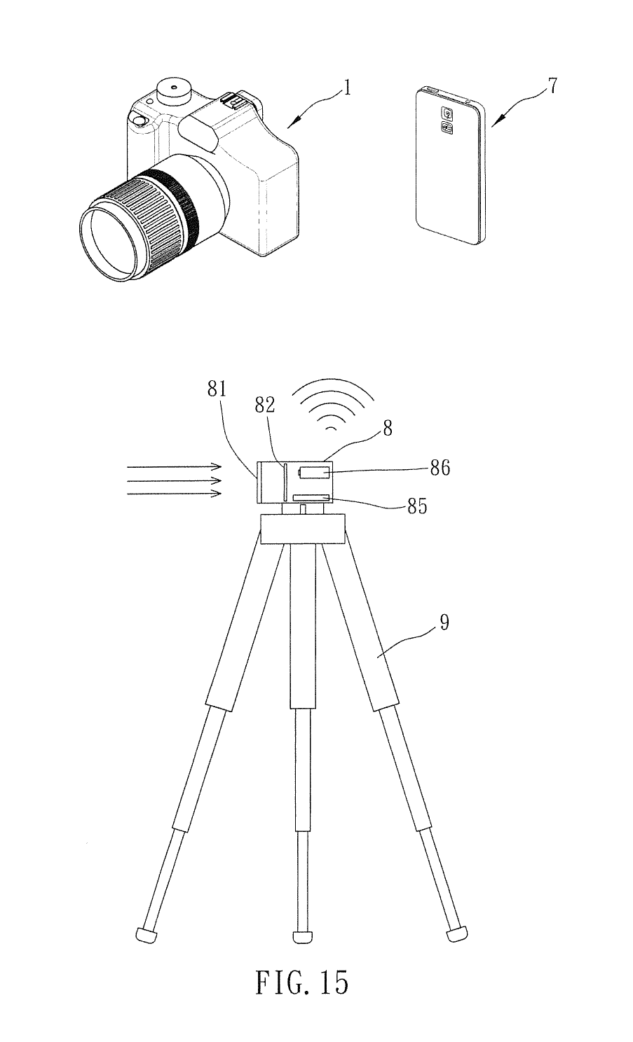

Referring to FIG. 15, the detachable white-balance color temperature measuring device 8 further comprises a wireless circuit 85 and a battery pack 86. The detachable white-balance color temperature measuring device 8 can be mounted at a camera tripod 9 at the scene for transmitting an accurate white balance (color temperature) signal to a camera phone 7, or a camera, video camera, tablet PC or any other image pick-up device 1, enabling a CPU 12 of the camera phone 7 or image pick-up device 1 to run a white balance calculation processing on the retrieved color temperature value and to further obtain an accurate white balance (color temperature) value.

In conclusion, the invention provides a white-balance color temperature measuring device for automatically obtaining an accurate white balance (color temperature) value without any adjustment or color temperature detection, enabling the color of the captured photos or images to be close to the natural colors of the shooting scene.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A white-balance color temperature measuring device comprising a white or gray light transmitting sheet and a color temperature sensing element and installed in a camera body of a camera, video camera or image pick-up device, for enabling incident light passing through a camera lens into a CCD or CMOS image sensor to be synchronously changed by said white or gray light transmitting sheet into a neutral light that falls upon said color temperature sensing element, causing said color temperature sensing element to induce a spot color temperature signal and to provide the signal to a CPU of said camera, video camera or image pick-up device where said CPU runs a white balance calculation processing on the retrieved color temperature value to obtain an accurate white balance (color temperature) value, so that the colors of the captured photos or images becomes close to the natural colors of the shooting scene.

2. The white-balance color temperature measuring device as claimed in claim 1, wherein said camera body defines therein an accommodation chamber adapted for accommodating said white or gray light transmitting sheet and said color temperature sensing element therein.

3. The white-balance color temperature measuring device as claimed in claim 1, wherein said white or gray light transmitting sheet and said color temperature sensing element are mounted at one side in a flash in a camera phone or table computer.

4. The white-balance color temperature measuring device as claimed in claim 3, wherein said white or gray light transmitting sheet and said color temperature sensing element are mounted at one side adjacent to a front camera lens or rear camera lens of a camera phone.

5. The white-balance color temperature measuring device as claimed in claim 1, wherein said white or gray light transmitting sheet is disposed beyond the image range of said CCD or CMOS image sensor so that when focusing or pressing the shutter of said camera, incident light passes through said camera lens into a light path in said camera, video camera or image pick-up device and is then changed into a neutral light by said white or gray light transmitting sheet and then guided to said CCD or CMOS image sensor, enabling said CPU to run a white balance calculation processing on the retrieved color temperature value and to further obtain an accurate white balance (color temperature) value.

6. A white-balance color temperature measuring device, comprising a white or gray light transmitting sheet and a color temperature sensing element mounted within a camera body in a light path of a camera lens beneath a pentaprism without affecting the line of sight so that when an incident light passes through said camera lens into said light path, said incident light falls upon said white or gray light transmitting sheet and is then changed into uniform neutral light and then guided to said color temperature sensing element, causing said color temperature sensing element to induce a spot color temperature signal and to provide the signal to a CPU where said CPU runs a white balance calculation processing on the retrieved color temperature value to obtain an accurate white balance (color temperature) value.

7. The white-balance color temperature measuring device as claimed in claim 6, wherein said white or gray light transmitting sheet and said color temperature sensing element are mounted in a camera phone or tablet computer in a light path of a front or rear camera lens so that when focusing or pressing the shutter of said camera, incident light passing said camera lens into said light path is changed into a neutral light by said white or gray light transmitting sheet and guided to said color temperature sensing element, causing said color temperature sensing element to induce a spot color temperature signal and to provide the signal to a CPU of said camera phone or tablet computer, where said CPU runs a white balance calculation processing on the retrieved color temperature value to obtain an accurate white balance (color temperature) value.

8. The white-balance color temperature measuring device as claimed in claim 7, wherein said camera phone having said white or gray light transmitting sheet and said color temperature sensing element and a white balance algorithm installed therein is operated to obtain a scene white balance value and then to transmit the scene white balance value to a CPU of a camera, video camera, camera phone or tablet computer by a wired or wireless transmission method for further computing, and an application program in the camera, video camera, camera phone or tablet computer is operated to transmit the white balance value.

9. A detachable white-balance color temperature measuring device, comprising a white or gray light transmitting sheet, a color temperature sensing element and a power and signal connector mounted within an outer shell thereof, said power and signal connector being plugged into a jack in a camera lens or camera body of a camera, video camera, camera phone, tablet PC or image pick-up device, so that incident light passing through said white or gray light transmitting sheet is changed into uniform neutral light that falls upon said color temperature sensing element, causing said color temperature sensing element to induce a spot color temperature signal and to provide the signal to a CPU of said camera, video camera, camera phone, tablet PC or image pick-up device, where said CPU runs a white balance calculation processing on the retrieved color temperature value to obtain an accurate white balance (color temperature) value.

10. The detachable white-balance color temperature measuring device as claimed in claim 9, further comprising a power and signal connecting mount attachable to a flash attachment of a camera or video camera and electrically connectable to electric contacts in said flash attachment for obtaining an accurate white balance (color temperature) signal, enabling incident light to pass through said white or gray light transmitting sheet and to be changed by said white or gray light transmitting sheet into uniform neutral light that falls upon said color temperature sensing element, causing said color temperature sensing element to induce a spot color temperature signal and to provide the signal to a CPU of said camera or video camera for processing.

11. The white-balance color temperature measuring device as claimed in claim 9, further comprising a wireless circuit and a battery pack, said wireless circuit being adapted to transmit said accurate white balance (color temperature) signal to a CPU of a camera, camera phone, video camera or tablet PC for processing.
